(19) United States
(12) Patent Application Publication
(10) Pub. No.: US 2023/0266787 A1
(43) Pub. Date: Aug. 24, 2023

(54) OPERATION DEVICE

(71) Applicant: ALPS ALPINE CO., LTD., Tokyo (JP)

(72) Inventors: Masashi ITO, Miyagi (JP); Masatoshi ONO, Miyagi (JP); Norimasa OKANISHI, Miyagi (JP)

(21) Appl. No.: 18/308,099

(22) Filed: Apr. 27, 2023

Related U.S. Application Data
(63) Continuation of application No. PCT/JP2021/040420, filed on Nov. 2, 2021.

(30) Foreign Application Priority Data
Nov. 5, 2020 (JP) 2020-184845

(51) Int. Cl. G05G 9/047

(52) U.S. Cl. CPC G05G 9/047; G05G 2009/04718; G05G 2009/04777

(57) ABSTRACT

An operation device includes a tiltable lever, a driving body coupled to the lever and configured to apply a return force to the lever when the lever is tilted, a metal plate provided to oppose a contact part provided and having an upper surface on which the contact part slides while making elastic contact when the lever is tilted, and a flexible substrate provided on the upper surface of the metal plate in an overlapping manner. The metal plate includes a control part having a groove shape and provided in the upper surface of the metal plate outside a region where the contact part slides, and configured to control bleeding of grease, and a convex part famed on a back surface of the metal plate, opposite to the upper surface, at a position corresponding to the control part. The flexible substrate covers an upper surface of the control part.

### CROSS-REFERENCE TO RELATED APPLICATIONS

This application is a continuation application of International Application No. PCT/JP2021/040420 filed on Nov. 2, 2021 and designated the U.S., which is based upon and claims priority to Japanese Patent Application No. 2020-184845 filed on Nov. 5, 2020, the entire contents of which are incorporated herein by reference.

### BACKGROUND OF THE INVENTION

### 1. Field of the Invention

The present disclosure relates to operation devices.

### 2. Description of the Related Art

As an example, Japanese Laid-Open Patent Publication No. 2011-233435 proposes a technique for providing an annular groove part for preventing bleeding of a lubricant, at an upper surface of a cover member on which a driving part of an operating body slides, in a multi-directional input device. In addition, Japanese Laid-Open Patent Publication No. 2011-233435 illustrates a convex part provided on a back surface of the cover member. Such a convex part can achieve effects that include increasing a rigidity of the cover member, stably fixing the back surface of the cover member with respect to an installing target surface, or the like.

However, according to the technique disclosed in Japanese Laid-Open Patent Publication No. 2011-233435, it is necessary to form the convex part on the cover member, in addition to forming the groove part in the cover member. Hence, it is necessary to prepare molds used to form the groove part and the convex part, respectively, and it is not possible to easily form the convex part.

### SUMMARY OF THE INVENTION

An operation device according to one aspect of embodiments includes a tiltable lever; a driving body coupled to a lower portion of the lever and configured to apply a return force to the lever when the lever is tilted; a metal plate provided to oppose a contact part provided at a lower end of the driving body, and having an upper surface on which the contact part slides while making elastic contact when the lever is tilted; and a flexible substrate provided on the upper surface of the metal plate in an overlapping manner, wherein the metal plate includes a control part having a groove shape and provided in the upper surface of the metal plate outside a region where the contact part slides, and configured to control bleeding of grease, and a convex part formed on a back surface of the metal plate, opposite to the upper surface, at a position corresponding to the control part, and the flexible substrate covers an upper surface of the control part.

Other objects and further features of the present invention will be apparent from the following detailed description when read in conjunction with the accompanying drawings.

### BRIEF DESCRIPTION OF THE DRAWINGS

FIG. 1 is an external perspective view of an operation device according to one embodiment;

FIG. 2 is an external perspective view of the operation device according to one embodiment in a state where a case thereof is removed;

FIG. 3 is a disassembled perspective view of the operation device according to one embodiment;

FIG. 4 is a cross sectional view of the operation device according to one embodiment;

FIG. 5 is an external perspective view illustrating a configuration of a top side of a frame according to one embodiment;

FIG. 6 is an external perspective view illustrating a configuration of a back side of the frame according to one embodiment;

FIG. 7 is a cross sectional view of the frame according to one embodiment along a YZ-plane; and

FIG. 8 is a partially enlarged cross sectional view of the operation device according to one embodiment.

### DESCRIPTION OF THE PREFERRED EMBODIMENTS

Embodiments of the operation device according to the present disclosure will be described in the following.

One aspect of the embodiments is to easily form a convex part on a back surface of a metal plate in an operation device that includes a control (or preventing or restricting) part configured to control bleeding of grease on an upper surface of the metal plate.

<Outline of Operation Device 100>

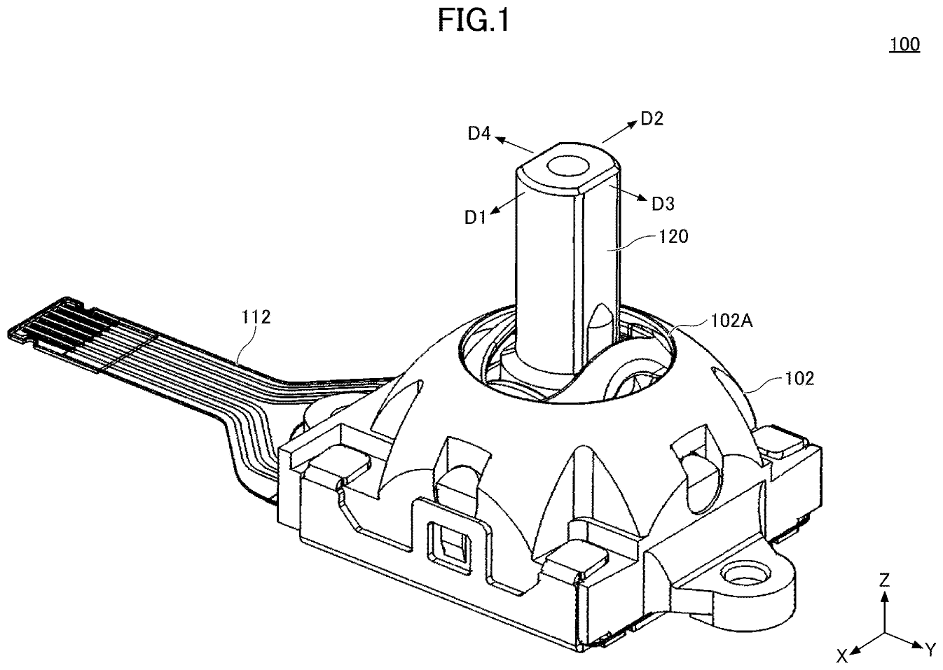

FIG. 1 is an external perspective view of an operation device 100 according to one embodiment. In the following description, for the sake of convenience, a Z-axis direction in the drawings may also be referred to as an up-down direction, an X-axis direction in the drawings may also be referred to as a front-rear direction, and a Y-axis direction in the drawings may also be referred to as a left-right direction.

The operation device 100 illustrated in FIG. 1 is used for a controller or the like of a game machine, a game console, or the like. As illustrated in FIG. 1, the operation device 100 has a columnar, tiltable lever 120 that extends upward from an opening 102A of a case 102. The lever 120 of the operation device 100 is tiltable not only in the front-rear direction (directions indicated by arrows D1 and D2 in FIG. 1) and the left-right direction (directions indicated by arrows D3 and D4 in FIG. 1), but is tiltable in all directions in between these directions. In addition, the operation device 100 is configured to output an operation signal corresponding to a tilt operation (a tilt direction and a tilt angle) performed with respect to the lever 120 to an outside via a flexible printed circuit (FPC) 112.

<Configuration of Operation Device 100>

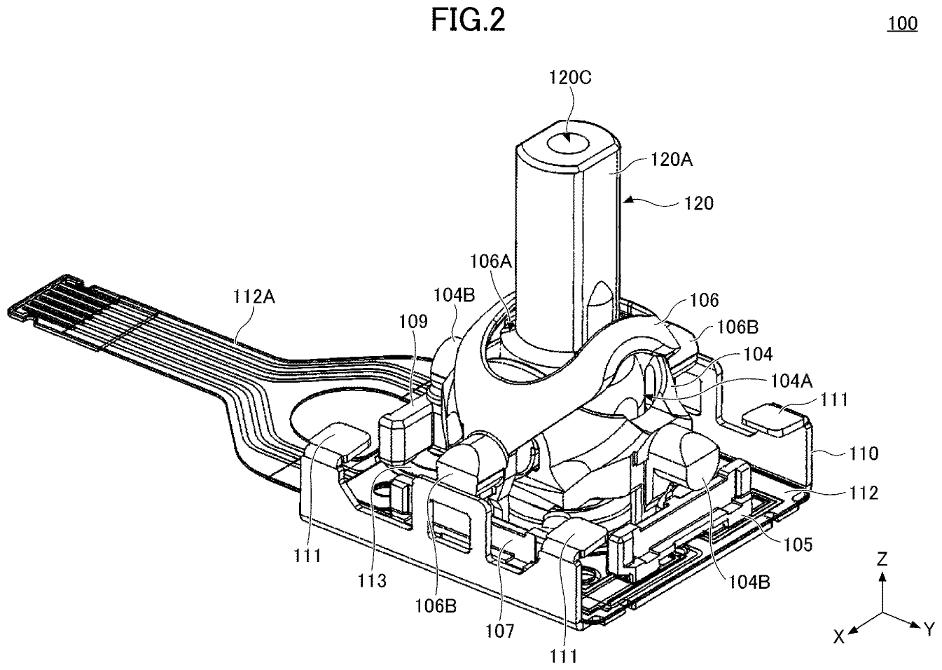

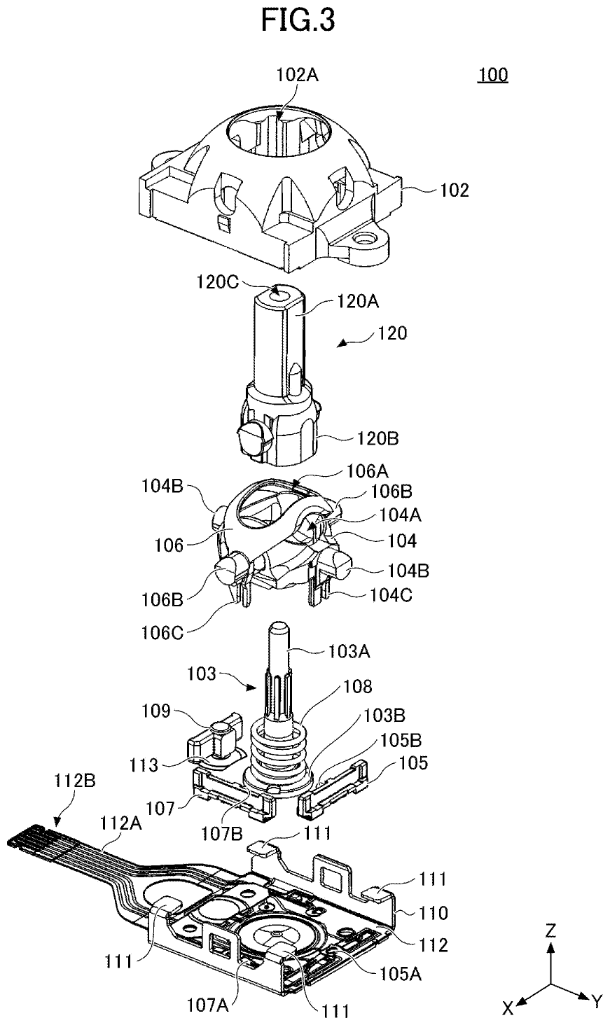

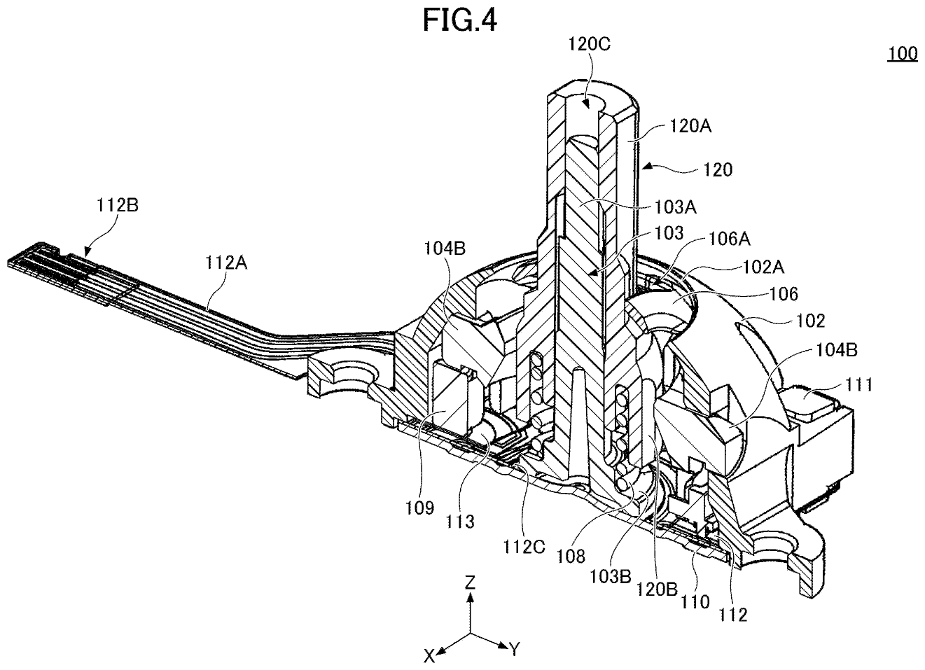

FIG. 2 is an external perspective view of the operation device 100 according to one embodiment in a state where the case 102 thereof is removed. FIG. 3 is a disassembled perspective view of the operation device 100 according to one embodiment. FIG. 4 is a cross sectional view of the operation device 100 according to one embodiment.

As illustrated in FIG. 2 through FIG. 4, the operation device 100 includes the case 102, the lever 120, an actuator 104, a holder 105, an actuator 106, an actuator 103, a spring 108, a holder 107, a pressing member 109, a frame 110, the FPC 112, and a metal sheet 113.

The case 102 has an upwardly convex dome shape. Constituent elements or components, such as the lever 120, the actuators 103, 104, and 106, and the holders 105 and 107, are assembled inside an inner space of the case 102. The case 102 is famed with an opening 102A having a circular shape in a plan view from above, at a top portion of the dome shape thereof.

The lever 120 is a member that is tiltable by an operator. The lever 120 has a lever part 120A, and a base part 120B. The lever part 120A is an approximately cylindrical part extending upward from the opening 102A of the case 102, and is tilted when a tilt operation is performed with respect to the lever part 120A by the operator. The base part 120B is an approximately cylindrical part that supports a lower end portion of the lever 120 inside the case 102, and moves rotationally according to the tilt operation performed with respect to the lever part 120A.

The actuator 104 has a curved upwardly convex dome shape, and has an elongated opening 104A extending in the left-right direction (Y-axis direction in FIG. 2 and FIG. 3) along the curved shape. The actuator 104 has a rotating shaft 104B having both end portions thereof in the left-right direction protruding outward. The rotating shaft 104B is supported by the case 102, so that the actuator 104 can move rotationally in the front-rear direction (X-axis direction in FIG. 2 through FIG. 4) around the rotating shaft 104B as a rotation center thereof.

The actuator 106 is provided above the actuator 104 in an overlapping manner. The actuator 106 has a curved upwardly convex shape, and has an elongated opening 106A extending in the front-rear direction (X-axis direction in FIG. 2 through FIG. 4) along the curved shape. The actuator 106 has a rotating shaft 106B having both end portions thereof in the front-rear direction protruding outward. The rotating shaft 106B is supported by the case 102, so that the actuator 106 can move rotationally in the left-right direction (Y-axis direction in FIG. 2 through FIG. 4) around the rotating shaft 106B as a rotation center thereof.

The holder 105 holds a slider 105A on a lower side thereof. The holder 105 has a longitudinal shape extending in a sliding direction (X-axis direction) of the slider 105A. The holder 105 is provided in a manner slidable in the sliding direction (X-axis direction) of the slider 105A. A protrusion 105B is provided at a center portion of a side surface of the holder 105.

The holder 107 holds a slider 107A on a lower side thereof. The holder 107 has a longitudinal shape extending in a sliding direction (Y-axis direction) of the slider 107A. The holder 107 is provided in a manner slidable in the sliding direction (Y-axis direction) of the slider 107A. A protrusion 107B is provided at a center portion of a side surface of the holder 107.

As illustrated in FIG. 2 through FIG. 4, the actuator 104 and the actuator 106 overlap each other so that the opening 104A and the opening 106A intersect each other. In a state where the actuator 104 and the actuator 106 overlap each other, the lever part 120A of the lever 120 penetrates the opening 104A and the opening 106A, and the actuator 104 engages the base part 120B of the lever 120, so as to be assembled inside the case 102.

The actuator 104 has an engaging part 104C that protrudes downward from the rotating shaft 104B on a positive side of the Y-axis. The engaging part 104C engages the protrusion 105B provided at the center portion of the side surface of the holder 105 that is provided in a manner slidable in the front-rear direction (X-axis direction) on the FPC 112. When the tilt operation in the front-rear direction (X-axis direction) is performed with respect to the lever 120, the actuator 104 moves rotationally in the front-rear direction together with the base part 120B of the lever 120, and causes the holder 105 to slide in the front-rear direction. Hence, a state of electrical connection between the slider 105A held at the lower portion of the holder 105, and a resistor provided on the FPC 112 changes. The operation signal corresponding a resistance of the resistor according to the tilt operation (the tilt direction and the tilt angle) in the front-rear direction performed with respect to the lever 120, is output to the outside via a connecting part 112B of the FPC 112.

The actuator 106 has an engaging part 106C that protrudes downward from the rotating shaft 106B on a positive side of the X-axis. The engaging part 106C engages the protrusion 107B provided at the center portion of the side surface of the holder 107 that is provided in a manner slidable in the left-right direction (Y-axis direction) on the FPC 112. When the tilt operation in the left-right direction (Y-axis direction) is performed with respect to the lever 120, the actuator 106 moves rotationally in the left-right direction together with the base part 120B of the lever 120, and causes the holder 107 to slide in the left-right direction. Hence, a state of electrical connection between the slider 107A held at the lower portion of the holder 107, and the resistor provided on the FPC 112 changes. The operation signal corresponding the resistance of the resistor according to the tilt operation (the tilt direction and the tilt angle) in the left-right direction performed with respect to the lever 120, is output to the outside via the connecting part 112B of the FPC 112.

The actuator 103 is an example of “a driving body”. The actuator 103 has a shaft part 103A, and a bottom plate part 103B. The shaft part 103A is a round bar-shaped part that is inserted into a through hole 120C of the lever 120. The bottom plate part 103B is a disk-shaped part integrally provided on a lower end portion of the shaft part 103A. The actuator 103 is connected to a lower portion of the lever 120, and applies a return force to the lever 120 using a biasing force from the spring 108 when the lever 120 is tilted.

The spring 108 is assembled inside an opening (refer to FIG. 4) on a bottom side (negative side of the Z-axis) of the lever 120, together with the actuator 103, in a state where the shaft part 103A of the actuator 103 is inserted into the spring 108. The spring 108 urges the lever 120 upward, and urges the bottom plate part 103B of the actuator 103 downward. Hence, when the tilt operation performed by the operator with respect to the lever 120 is canceled and the lever 120 is released, the spring 108 presses the bottom plate part 103B of the actuator 103 against an upper surface and a center portion of the frame 110, and causes the bottom plate part 103B to assume a horizontal state, to thereby return the lever 120 to a neutral state.

When the lever 120 is depressed downward, the pressing member 109 is pressed downward by the rotating shaft 104B on the negative side of the Y-axis of actuator 104. As a result, the metal sheet 113 provided on the FPC 112 is pressed downward and elastically deformed, thereby putting a switch circuit formed on the FPC 112 into a conductive state (or on state). Hence, a switch-on signal, indicating that the lever 120 is depressed downward, is output from the FPC 112.

The frame 110 is an example of “a metal plate”, and is a flat plate-shaped member made of a metal. The frame 110 closes the opening at a bottom side of the case 102. For example, the frame 110 can be formed by performing various processes or steps on a metal plate, such as punching, bending, or the like, for example. The frame 110 is provided with a pair of claw parts 111 at each of an edge portion on the front side (positive side of the X-axis) and an edge portion on the rear side (negative side of the X-axis). That is, the claw part 111 is provided at each of four approximate corner portions of the frame 110 having a rectangular shape, by bending or the like. The frame 110 is fixed with respect to the case 102, by engaging each of the claw parts 111 to an edge portion at each of four approximate corner portions of the case 102. Hence, the frame 110 functions as a fixing frame for fixing the operation device 100 to an installing target surface.

The FPC 112 is an example of “a substrate”, and is a flexible film-like interconnection member. The FPC 112 has an extending part 112A extending from an upper surface of the frame 110 to a side of the frame 110 (negative Y-axis direction in FIG. 3 and FIG. 4), and is electrically connected to the outside by the connecting part 112B that is provided on a tip end of the extending part 112A. The FPC 112 transmits, to the outside, the operation signal according to the operation (tilt operation and depressing operation) of the lever 120. The FPC 112 is formed by covering both surfaces of conductive interconnect strips (foamed of copper foil or the like, for example) with a film of flexible and insulating material (formed of polyimide resin, polyethylene terephthalate (PET), or the like, for example).

<Configuration of Frame 110>

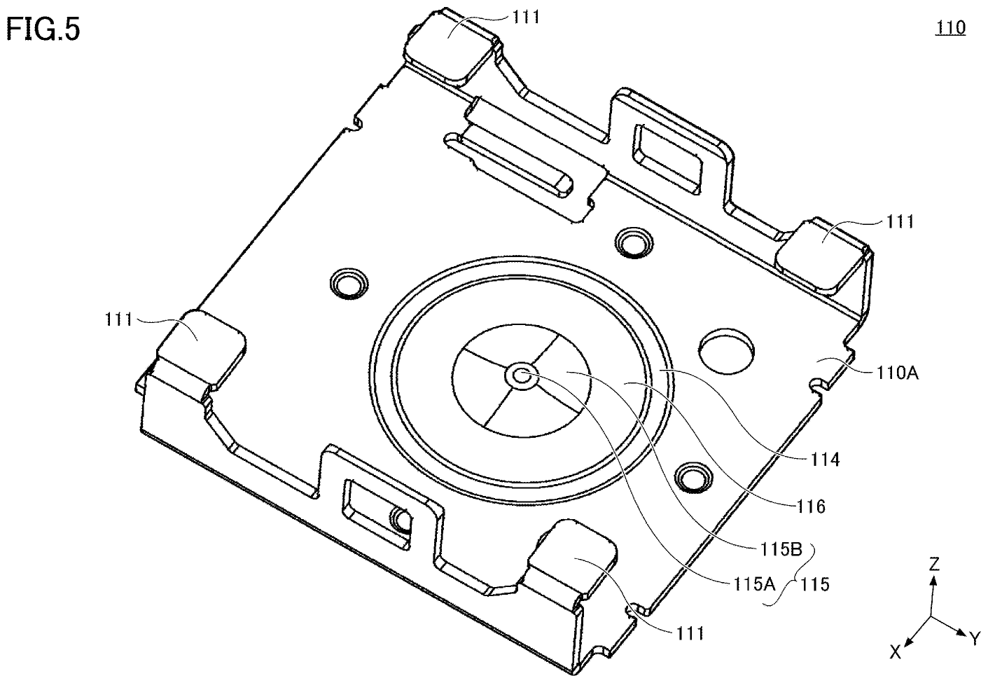

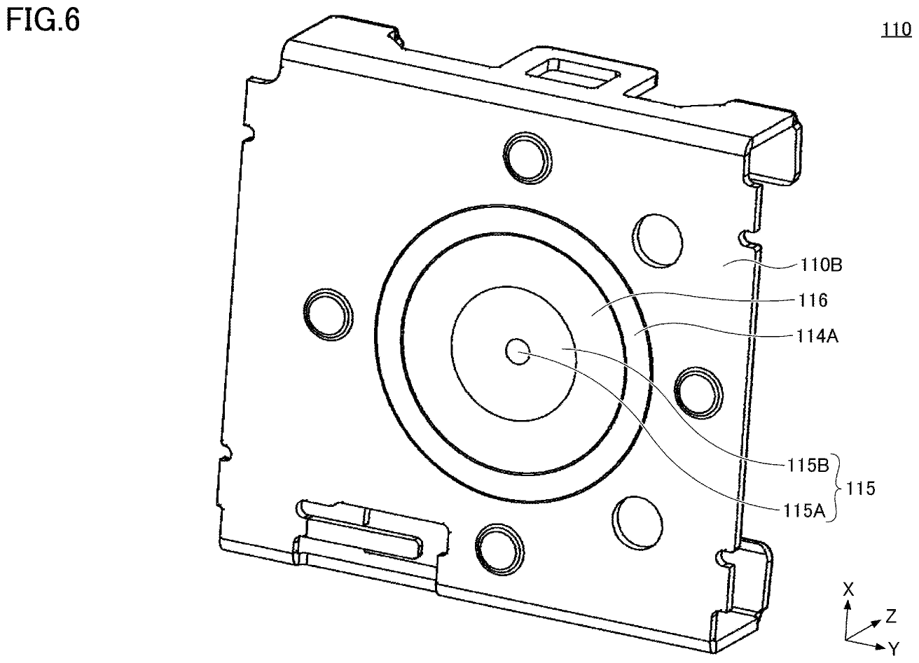

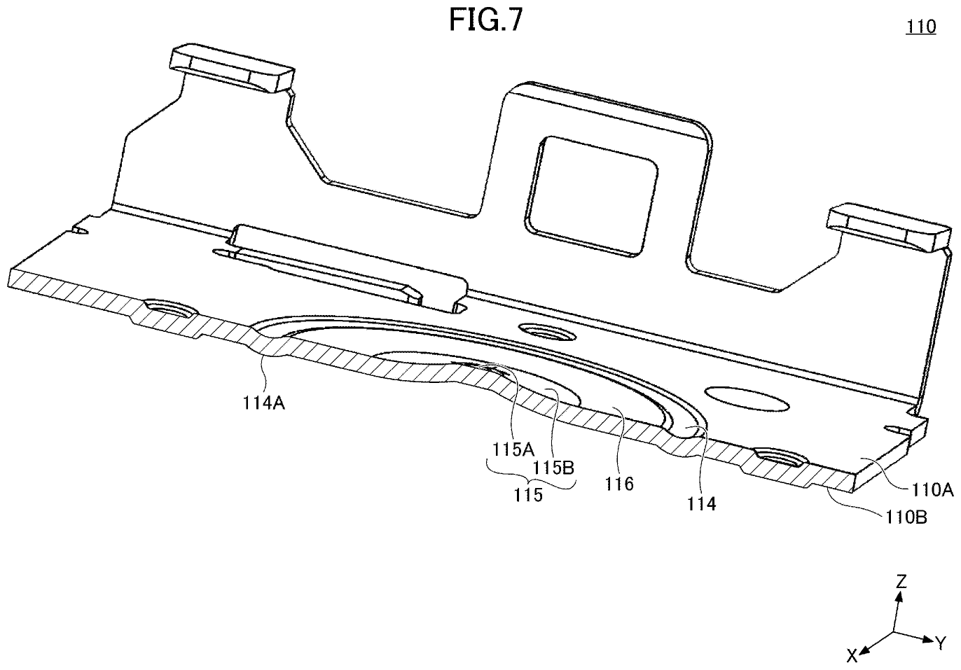

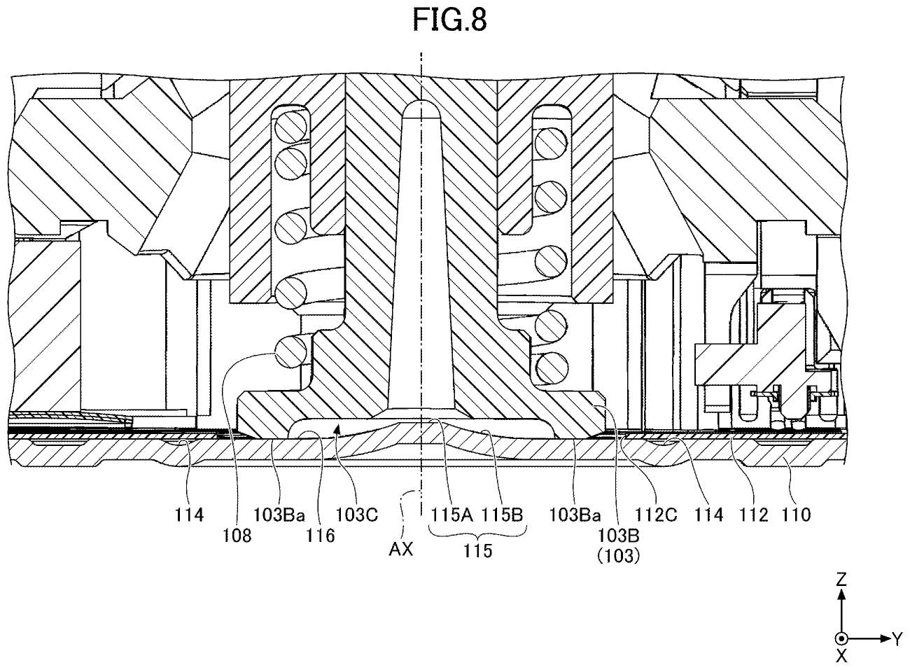

FIG. 5 is an external perspective view illustrating a configuration of a top side at an upper surface 110A of the frame 110 according to one embodiment. FIG. 6 is an external perspective view illustrating a configuration of a back side at a back surface 110B of the frame 110 according to one embodiment. FIG. 7 is a cross sectional view of the frame 110 according to one embodiment along a YZ-plane. FIG. 8 is a partially enlarged cross sectional view of the operation device 100 according to one embodiment.

As illustrated in FIG. 5 through FIG. 8, a convex part 115 is provided at an approximate center of the frame 110. The convex part 115 is a generally truncated conical part that protrudes upward from the upper surface 110A of the frame 110. The convex part 115 can be formed by applying pressure to the frame 110 from the back surface 110B by pressing, to deform the frame 110. The convex part 115 has a top portion 115A provided at a center thereof, and a sloping surface 115B that is inclined so as to gradually increase in altitude toward the top portion 115A. As illustrated in FIG. 8, in the frame 110, the convex part 115 is formed under the bottom plate part 103B of the actuator 103, and on a center axis AX of the actuator 103.

As illustrated in FIG. 8, a cavity part 103C, having a shape recessed upward, is famed in a bottom surface of the bottom plate part 103B of the actuator 103. The cavity part 103C has a circular shape having the center axis AX as a center thereof in the plan view. As illustrated in FIG. 8, the cavity part 103C is provided so as to enable a contact part 103Ba of the actuator 103 to make contact with the upper surface 110A of the frame 110, while avoiding contact of the convex part 115 of the frame 110 with the bottom surface of the bottom plate part 103B of the actuator 103.

Because the cavity part 103C is foiled in the bottom surface of the bottom plate part 103B of the actuator 103, the annular contact part 103Ba is formed to surround the cavity part 103C. As illustrated in FIG. 8, when the actuator 103 is in a neutral state, the contact part 103Ba makes contact with an annular flat part 116 of the upper surface 110A of the frame 110 throughout the entire annular shape of the annular flat part 116. The neutral state of the actuator 103 is stabilized when the contact part 103Ba is pressed against the annular flat part 116 by the urging force of the spring 108.

When the lever 120 is tilted from the neutral state, a portion of the contact part 103Ba of the actuator 103 slides from the annular flat part 116 toward the top portion 115A of the convex part 115, while elastically contacting the sloping surface 115B of the convex part 115. In this state, because the actuator 103 approaches the lever 120, the spring 108 is compressed more than in the neutral state and increases the biasing force.

When the tilt operation performed with respect to the lever 120 is canceled and the lever 120 is released from this tilted state, a portion of the contact part 103Ba of the actuator 103 slides from the top portion 115A of the convex part 115 toward the annular flat part 116, while elastically contacting the sloping surface 115B of the convex part 115 due to the biasing force of the spring 108, and reaches the annular flat part 116. Hence, the contact part 103Ba makes contact with the annular flat part 116 throughout the entire annular shape of the annular flat part 116, thereby returning the actuator 103 to the neutral state.

In the operation device 100 according to one embodiment, a control (or preventing or restricting) part 114 having a shape recessed downward (that is, a groove shape) is formed in the upper surface 110A of the frame 110. The control part 114 has an annular shape centered on the convex part 115 in the plan view. Because the control part 114 is formed in the upper surface 110A of the frame 110, the annular flat part 116 having the annular shape is formed between the control part 114 and the convex part 115. The convex part 115 and the annular flat part 116 are regions where the contact part 103Ba of the actuator 103 slides when the actuator 103 is tilted. That is, the control part 114 has the annular shape surrounding the convex part 115 and the annular flat part 116. More particularly, a diameter of the control part 114 is larger than a diameter of the bottom plate part 103B of the actuator 103, so as to surround the regions (that is, the convex part 115 and the annular flat part 116) where the contact part 103Ba of the actuator 103 slides. Grease for providing lubrication and smoothening the sliding of the contact part 103Ba is applied to surfaces of the convex part 115 and the annular flat part 116. When the actuator 103 is tilted, the control part 114 can store the grease swept out by the contact part 103Ba in the direction opposite to the tilting direction of the actuator 103. Thus, the control part 114 can control the grease swept out in the direction opposite to the tilting direction of the actuator 103, and prevent the grease from bleeding to an outer side of the control part 114. For example, when the actuator 103 is tilted in the positive X-axis direction, the contact part 103Ba of the actuator 103 moves in the negative X-axis direction. In this state, the grease applied to the convex part 115 and the annular flat part 116 is swept out in the negative X-axis direction by a portion on the negative side of the X-axis of the contact part 103Ba, but the grease enters the control part 114, thereby controlling and minimizing the bleeding of the grease to the outer side of the control part 114. As a result, the operation device 100 according to one embodiment can control and minimize the grease from adhering between the resistor provided on the FPC 112 and the sliders 105A and 107A held at the lower portions of the holders 105 and 107, for example.

In the operation device 100 according to one embodiment, the control part 114 can be formed by applying pressure to the frame 110 from the upper surface 110A by pressing, to deform the frame 110. Hence, as illustrated in FIG. 6 and FIG. 7, when the control part 114 is formed, a convex part 114A that is downwardly convex, having a shape (that is, annular shape) identical to the shape of the control part 114, is famed on the back surface 110B of the frame 110 at a position identical to the position of the control part 114 in the plan view.

Because the convex part 114A is provided on the back surface 110B of the frame 110 in the operation device 100 according to one embodiment, it is possible to increase a rigidity of the frame 110 while reducing a thickness of the frame 110. Accordingly, the operation device 100 according to one embodiment can control and reduce deformation of the frame 110, even in a case where the depressing operation of the lever 120 is performed, for example.

In addition, because the frame 110 has the convex part 114A in the operation device 100 according to one embodiment, when fixing the back surface 110B of the frame 110 to the installing target surface (for example, a wall surface or the like inside a housing of a game controller), for example, the annular convex part 114A makes contact with the installing target surface, thereby enabling the back surface 110B of the frame 110 to be stably fixed.

In particular, by forming the control part 114 in the upper surface 110A of the frame 110 in the operation device 100 according to one embodiment, the convex part 114A can be formed on the back surface 110B of the frame 110. Hence, in the operation device 100 according to one embodiment, it is possible to easily form the convex part on the back surface of the metal plate in the operation device having the control part for controlling the bleeding of the grease in the upper surface of the metal plate.

Moreover, because the control part 114 and the convex part 114A have the annular shape in the plan view in the operation device 100 according to one embodiment, it is possible to prevent the grease from bleeding to the outer side of the control part 114, even when the tilting direction of the actuator 103 is in any direction of the 360° directions, and to more stably fix the back surface 110B of the frame 110 to the installing target surface.

Further, in the operation device 100 according to one embodiment, the FPC 112 (an example of “the flexible substrate”) is provided in an overlapping manner on the upper surface 110A of the frame 110. As illustrated in FIG. 4 and FIG. 8, the FPC 112 has an opening edge portion 112C outside a region (that is, the convex part 115 and the annular flat part 116) where the contact part 103Ba of the actuator 103 slides. Hence, the operation device 100 according to one embodiment can cause the grease, swept out in the direction opposite to the tilting direction of the actuator 103, to flow between the FPC 112 and the upper surface 110A of the frame 110, from the opening edge portion 112C of the FPC 112. For this reason, the operation device 100 according to one embodiment can prevent the grease, swept out in the direction opposite to the tilting direction of the actuator 103, from bleeding to the upper surface of the FPC 112.

In particular, the FPC 112 is fixed to the frame 110 by an arbitrary fixing means, on the outer side of the region (that is, the convex part 115 and the annular flat part 116) where the contact part 103Ba of the actuator 103 slides. As a result, the operation device 100 according to one embodiment can partially raise the opening edge portion 112C of the FPC 112 upward, so that the grease swept out in the direction opposite to the tilting direction of the actuator 103 can easily flow in between the FPC 112 and the upper surface 110A of the frame 110.

In the operation device 100 according to one embodiment, the frame 110 includes the plurality of claw parts 111 formed at the outer peripheral edge portion of the frame 110 by bending. The plurality of claw parts 111 engages the edge portion of the case 102 of the operation device 100, and the control part 114 is formed between an arbitrary pair of adjacent claw parts 111 in the plan view (refer to FIG. 5). That is, in FIG. 5, in a case where two virtual extension regions are defined by extending, in the X-axis direction, an end portion on the positive side of the Y-axis and an end portion on the negative side of the Y-axis of each of the pair of claw parts 111 that are bent to oppose each other in the X-axis direction, so as to connect to one another, respectively, the two virtual extension regions and the control part 114 do not overlap in the plan view of the frame 110 illustrated in FIG. 5, and the control part 114 is formed between the two virtual extension regions provided on the positive side of the Y-axis and the negative side of the Y-axis. Accordingly, in the operation device 100 according to one embodiment, when forming the plurality of claw parts 111 by bending, because the control part 114 and the convex part 114A are formed at positions separated from the region that is easily affected by the bending, it is possible to control and minimize distortion caused by the bending, that is, it is possible to form the control part 114 and the convex part 114A with a high accuracy.

According to the embodiments described above, it is possible to easily form a convex part on a back surface of a metal plate in an operation device including a control part configured to control bleeding of grease on an upper surface of the metal plate.

Although examples of the operation device according to the embodiments of the present invention are described heretofore, the present invention is not limited to the specifically disclosed embodiments, and various variations, modifications, and substitutions can be made without departing from the scope of the present invention.

For example, the shapes of the control part 114 and the convex part 114A are not limited to the annular shape. The shapes of the control part 114 and the convex part 114A may be a polygonal (for example, quadrangular) picture-frame shape. In addition, the shapes of the control part 114 and the convex part 114A may be a shape in which a portion of the annular shape is truncated, a shape in which a portion of the polygonal picture-frame shape is truncated, or the like, for example. Moreover, the control part 114 and the convex part 114A are preferably provided at least in a direction opposite to the tilting direction of the actuator 103. For example, in a case where the actuator 103 is tiltable only in the X-axis direction, the control part 114 and the convex part 114A can be provided only in the X-axis direction and not be provided in the Y-axis direction.

What is claimed is:

1. An operation device comprising:
a tiltable lever;
a driving body coupled to a lower portion of the lever and configured to apply a return force to the lever when the lever is tilted;
a metal plate provided to oppose a contact part provided at a lower end of the driving body, and having an upper surface on which the contact part slides while making elastic contact when the lever is tilted; and
a flexible substrate provided on the upper surface of the metal plate in an overlapping manner, wherein
the metal plate includes
a control part having a groove shape and provided in the upper surface of the metal plate outside a region where the contact part slides, and configured to control bleeding of grease, and
a convex part formed on a back surface of the metal plate, opposite to the upper surface, at a position corresponding to the control part, and
the flexible substrate covers an upper surface of the control part.

2. The operation device as claimed in claim 1, wherein the control part and the convex part have an annular shape.

3. The operation device as claimed in claim 1, wherein the lever is depressible.

4. The operation device as claimed in claim 1, wherein the flexible substrate includes an opening edge portion outside a region where the contact part slides.

5. The operation device as claimed in claim 4, wherein the flexible substrate is fixed to the metal plate outside the region where the contact part slides.

6. The operation device as claimed in claim 1, wherein the metal plate functions as a fixing frame configured to fix the operation device.

7. The operation device as claimed in claim 1, wherein
the metal plate includes a plurality of claw parts formed by bending at an outer peripheral edge portion of the metal plate and configured to engage with a case of the operation device, and
the control part includes is formed between two arbitrary adjacent claw parts in a plan view.
